(19) United States
(12) Patent Application Publication
(10) Pub. No.: US 2014/0330736 A1
(43) Pub. Date: Nov. 6, 2014

(54) PERFORMING A CUSTOMS PROCEDURE

(71) Applicants: Hans Chelniak, Hockenheim (DE); Jochen Thierer, Bruchsal (DE); Christian Stadler, Mannheim (DE); Stefan Brunner, Oftersheim (DE); Andreas Moschel, Wald-Michelbach (DE)

(72) Inventors: Hans Chelniak, Hockenheim (DE); Jochen Thierer, Bruchsal (DE); Christian Stadler, Mannheim (DE); Stefan Brunner, Oftersheim (DE); Andreas Moschel, Wald-Michelbach (DE)

(21) Appl. No.: 14/335,585

(22) Filed: Jul. 18, 2014

Related U.S. Application Data
(63) Continuation of application No. 11/260,802, filed on Oct. 27, 2005.

(30) Foreign Application Priority Data
Oct. 27, 2004 (EP) 04077960.5

(51) Int. Cl. G06Q 10/08

(52) U.S. Cl. CPC G06Q 10/0831
USPC 705/331

(57) ABSTRACT

A method includes receiving an electronic logistics document containing logistics data of received goods, processing the logistics data, and generating an electronic customs declaration. Generating can include extracting from the logistics document logistics data, deriving from the extracted logistics data customs data related to a customs procedure, and generating for at least a part of the received goods an electronic customs declaration document containing the customs data. The method can include providing the electronic customs declaration document at an output interface, transmitting the electronic customs declaration document to an input interface of an electronic customs clearance declaration system, receiving, from the electronic customs clearance declaration system, clearance data regarding the received goods at a second input interface, and marking the logistics data with a first marking to signal that the customs procedure has been completed.

### CROSS REFERENCE TO RELATED APPLICATIONS

This application claims priority to European Application entitled “A method for performing a customs procedure,” filed on Oct. 27, 2004, Application No. EP 04077960.5, the entire contents of which are incorporated herein.

### BACKGROUND

The present invention relates to data processing by digital computer, and more particularly to performing a customs procedure.

In the past nearly all customs processes were paper based. Meanwhile most of the national customs authorities move on to organize their processes electronically. In the European Union (EU), the New Computerized Transit System (NCTS) system is defined for the transit procedure, in Germany several customs processes (i.e., free circulation) are defined in the Automatisiertes Tarif- and Lokales Zoll-Abwicklungs-System (ATLAS) definition, and in the United States (US) the customs authorities are working with the Automated Commercial Environment (ACE).

However, although the communication with the customs authorities is handled electronically, the customs processes strongly interfere with the corresponding logistic processes. The customs procedures and the corresponding logistic processes are still separated and often handled by different systems and different organizations within a company. This decelerates both the customs processes and the logistics processes.

Another problem is that in case of starting a new customs procedure, it may happen that in the logistics process, knowledge about the specific customs procedure the goods have to be declared for, is absent. The selection of a customs procedure is typically made by the person who is in charge of customs handling within a company.

In addition, when choosing a new customs procedure it may happen that not the whole quantity of goods receipt shall be declared for in the same customs procedure. For example, only a part of the goods may have to be declared for free circulation and another part may be declared for bonded warehouse at a later point in time.

### SUMMARY

The present invention provides methods and apparatus, including computer program products, for performing a customs procedure.

In general, in one aspect, the invention features a method for performing a customs procedure, the method including receiving at a first input interface of a data processing system an electronic logistics document, the logistics document containing logistics data of received goods, processing the logistics data in a logistics process performed by the data processing system, and generating by the data processing system an electronic customs declaration. The generating can include extracting from the logistics document logistics data, deriving from the extracted logistics data customs data related to a customs procedure, and generating for at least a part of the received goods by the data processing system an electronic customs declaration document containing the customs data. The method can include providing the electronic customs declaration document at an output interface of the data processing system, transmitting the electronic customs declaration document to an input interface of an electronic customs clearance declaration system, receiving, from the electronic customs clearance declaration system, clearance data regarding the received goods at a second input interface of the data processing system, and marking, within the data processing system, the logistics data with a first marking to signal that the customs procedure has been completed when the clearance data indicate that the customs procedure has been completed.

In embodiments, the method can include automatically determining from the logistics data whether or not a customs declaration can be required for the received goods. Generating the customs declaration can include selecting a customs procedure definition from a repository stored in a memory of the data processing system, which customs procedure definition at least defines a customs declaration document type suitable to be processed by the electronic customs clearance declaration system corresponding to the selected customs procedure, and generating a customs declaration document corresponding to the customs declaration document type of the selected customs procedure definition.

The customs procedure definition can be automatically selected from the repository. The method can include an identifier of the selected customs procedure definition to the logistics data, and/or adapting, in accordance with the received logistics data, a worklist stored in a memory of the data processing system, extracting from the worklist at least one procedure selection parameter, outputting the at least one procedure selection parameter at an output interface of the data processing system, receiving a selected procedure selection parameter at an input interface of the data processing system, and selecting a customs procedure definition based on the received procedure selection parameter.

The worklist can enable a common interface between at least one electronic logistics document and the data processing system. The worklist can enable a common interface between a predetermined number of groups of electronic logistics documents and the data processing system. The worklist can be stored in a memory of a customs procedure unit of the data processing system, and can include transferring at least part of the logistics data to the customs procedure unit.

The method can include automatically marking the logistics data to signal that the customs procedure has been completed when the received clearance data indicate that the customs procedure has been completed, and/or inhibiting processing of the logistics data by the data processing system until the customs clearance data indicate that the customs procedure has been completed.

The method can include allowing processing of the logistics data by the data processing system, in case the customs clearance data indicate that the customs procedure has been completed, and/or providing, within the data processing system, the logistics data with a second marking, which second marking signals that the customs procedure has not been completed, and removing the second marking in case customs clearance data can be received that indicate that the customs procedure has been completed.

Change, use or manipulation of logistics data can be marked with the second marking can be blocked. Providing the logistics data with the second marking signals that the received goods can be blocked or duty unpaid goods. The logistics document can be a goods receipt and the providing a second marking to the logistics data can include transmitting the goods receipt into a buffer memory and retaining the goods receipt in the buffer memory until the customs procedure has been completed.

Removing the second marking from the logistics data or providing the first marking to the logistics data can include discharging the goods receipt from the buffer memory. Change, use or manipulation of logistics data marked with the first marking can be allowed. Providing the logistics data with the first marking signals that the received goods can be unblocked or duty paid goods.

The method can include retaining received goods in blocked stock until the customs clearance data indicate that the customs procedure has been completed, and releasing the goods from blocked stock when the customs clearance data indicate that the customs procedure has been completed.

In another aspect, the invention features a data processing system including a first input interface for receiving an electronic logistics document containing logistics data of received goods, a second output interface for providing an electronic customs declaration document and transmitting the electronic customs declaration document to the electronic customs clearance declaration system, a second input interface for receiving customs clearance data from the electronic customs clearance declaration system, a memory for storing the logistics data, a processor connected to the input interfaces, the memory, and the output interfaces, the processor being arranged to extract from the logistics document logistics data, to derive from the extracted logistics data customs data related to a customs procedure, to generate for at least a part of the received goods an electronic customs declaration document containing the customs data, to provide the electronic customs declaration document at the second output interface, and to mark in accordance with the received clearance data the logistics data with a first marking to signal that the customs procedure has been completed when the clearance data indicate that the customs procedure has been completed.

In embodiments, the system can include a repository in which at least two customs procedure definitions can be stored, which customs procedure definitions can be each associated with at least one selection parameter and at least define a customs declaration document type suitable to be processed by an electronic customs clearance declaration system corresponding to the customs procedure definition, wherein the processor can be further arranged to select a customs procedure definition from the repository, and to generate a customs declaration document corresponding to the customs declaration document type of the selected customs procedure definition.

The system can include a first output interface for outputting the least one procedure selection parameter, wherein the processor can be further arranged to adapt, in accordance with the received logistics data, a worklist stored in a memory of the data processing system, to extract from the worklist at least one procedure selection parameter, to output the at least one procedure selection parameter at the first output interface of the data processing system, to receive a selected procedure selection parameter at a third input interface of the data processing system, and to select a customs procedure definition based on the received procedure selection parameter. The processor can be arranged to add an identifier of a selected customs procedure to the logistics data. The processor can be arranged to mark the logistics data with a second marking to signal that a customs procedure has not been completed until the clearance data indicate that the customs procedure has been completed. The processor can be arranged to inhibit a logistics process to be performed by the data processing system with the logistics data until the clearance data regarding the received goods indicate that the customs procedure has been completed. The processor can be arranged to allow a logistics process to be performed by the processing system with the logistics data in case the clearance data indicate that the customs procedure has been completed.

Other features and advantages of the invention are apparent from the following description, and from the claims.

### BRIEF DESCRIPTION OF THE DRAWINGS

FIG. 1 is a block diagram of an exemplary data processing system.

FIG. 2 is a flow diagram of an exemplary customs procedure.

Like reference numbers and designations in the various drawings indicate like

### DETAILED DESCRIPTION

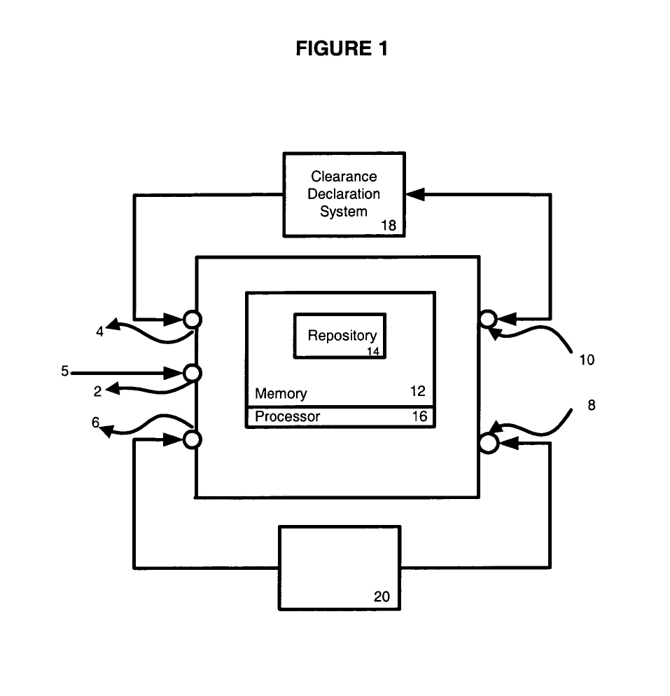

As shown in FIG. 1, an exemplary data processing system 1 includes a first input interface 2, a second input interface 4, a third input interface 6, a first output interface 8 and a second output interface 10. The data processing system 1 includes a memory 12. The data processing system 1 includes a processor 16 communicatively connected to the input interfaces, 2, 5, 4, 6, the memory 12, and the output interfaces 8, 10.

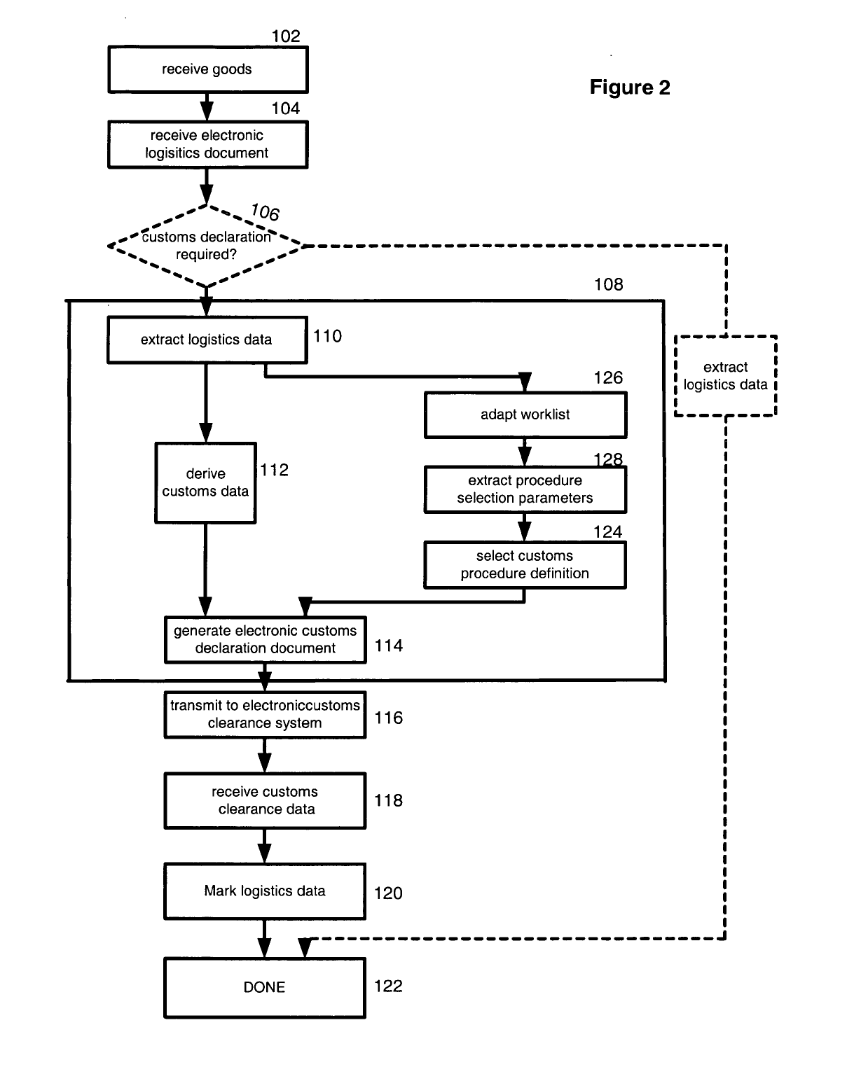

The operation of the system 1 as discussed thus far, will be elucidated referring to FIG. 2, which shows a process 100 for performing a customs procedure according to the invention.

In a logistic process goods may be received, e.g. on the premises of a user such as a company, as indicated in step 102. Logistics data of the received goods may be contained in or entered into an electronic logistics document concerning the received goods. At the first input interface 2 of the data processing system 1 the electronic logistics document is received in step 104. In the logistic process performed by the data processing system 1 the logistics data is processed. In step 106 it is determined whether or not a customs declaration is required for the received goods. The customs declaration usually must comply with a customs procedure which is usually prescribed by a customs authority of the country in which the goods are received. The data processing system 1 may automatically determine from the logistic data whether or not a customs declaration is required for the received goods, e.g. on the basis of a country of dispatch and/or a country of origin and/or a commodity code and/or a value of the goods and/or a type of customs document that has accompanied the goods. This provides the advantage that the workload on the user of the data processing system 1 is reduced, the risk of human error is reduced and/or that it can be determined whether or not a customs declaration is required for the received goods immediately after the corresponding logistics document has been provided at the first input interface 2 of the data processing system 1. It is, however, also possible, for example when it is known beforehand that all received goods require customs declaration, e.g. when the user is only concerned with import of goods that are subject to customs declaration, that the data processing system 1 does not determine from the logistics data whether or not a customs declaration is required for the received goods but always generates a customs declaration for received goods. In this case step 106 may be omitted.

In step 108 the data processing system 1 generates an electronic customs declaration. Generating the electronic customs declaration includes extracting logistics data from the logistics document (step 110). From the extracted logistics data customs data is derived in step 112. The customs data is related to the required customs procedure for at least a part of the received goods. It is possible that not the whole quantity of received goods shall be declared for one particular customs procedure. For example, only a part of the goods may have to be declared for free circulation and another part may be declared for bonded warehouse at a later point in time. In step 114 an electronic customs declaration document is generated for the relevant part of the received goods by the data processing system 1 containing the customs data.

The customs declaration document can be communicated, e.g. transmitted, to a customs authority. The customs declaration document can be transmitted in electronic form to a customs-server associated with the customs authority. Thereto, the electronic customs declaration document is provided at the second output interface 10 of the data processing system 1. The electronic customs declaration document is for example transmitted to an input interface of an electronic customs clearance declaration system 18 (e.g. NCTS, ATLAS or ACS) in step 116. The customs declaration document must comply with the customs procedure to be suitable to be processed by the customs clearance declaration system 18. At the electronic customs clearance system 18 the electronic customs declaration is processed and customs clearance may be awarded. Customs clearance may be transmitted by the customs authority, e.g. by the customs clearance declaration system 18, to the data processing system 1, e.g. in electronic form. Clearance data regarding customs clearance of the received goods are received from the electronic customs clearance declaration system 18 at the second input interface 4 of the data processing system 1 (step 118). Within the data processing system 1, when the clearance data indicate that the customs procedure has been completed, the logistics data are marked accordingly with a first marking (step 120). Thereto, the processor 16 is arranged to mark the logistics data with the first marking to signal that a customs procedure has been completed when the clearance data indicate that the customs procedure has been completed. This provides the advantage that within the data processing system 1, it can easily be recognized, from the first marking to the logistics data, whether or not a customs procedure regarding the received goods corresponding to the logistics data has been completed. At this point the customs procedure is completed (step 122) and the logistic process can be resumed.

In a special embodiment, the data processing system 1 is arranged to automatically handle customs clearance. That is, the data processing system 1 is arranged to receive the clearance data in electronic form and according to the clearance data automatically mark the logistics data to signal that the customs procedure has been completed. This provides the advantage that it is possible that the logistics data are marked to signal that the customs procedure has been completed immediately upon receiving the clearance data.

It is possible that many customs procedures exist. The customs authority may e.g. prescribe different customs procedures for goods received from different countries or regions, or for different types of goods. Within the data processing system 1 customs procedure definitions may be contained in a repository 14 stored in the memory 12 of the data processing system 1. Each customs procedure definition at least defines a customs declaration document type corresponding to the selected customs procedure. Preferably each customs declaration type is suitable to be processed by the electronic customs clearance declaration system.

In the example of FIG. 2 generating the electronic customs declaration (step 108) further includes selecting a customs procedure definition of the customs procedure definitions from the repository 14 stored in the memory 12 of the data processing system 1 (step 124). From the logistics data the customs data can be selected which are suitable for the selected customs procedure. The customs declaration document is subsequently generated corresponding to the customs declaration document type of the selected customs procedure definition. It is possible to add an identifier of the selected customs procedure definition to the logistics data, e.g. for future reference. Thereto, the processor 16 is arranged to add an identifier of the selected customs procedure to the logistics data.

Thus the method for performing the customs procedure, includes receiving at an input a delivery data about received goods, selecting from the delivery data customs data suitable for the selected customs process, adding an identifier of a selected customs process to the delivery data, and generating from the customs data a customs clearance (shipment) document suitable to be processed by the associated customs process.

The data processing system 1, thereto, includes an input for receiving a delivery data about received goods and a processor communicatively connected to the input, which processor is arranged to add an identifier of the selected customs process to the delivery data, to select from the delivery data customs data suitable for the selected customs process and to generate from the customs data a customs clearance (shipment) document suitable to be processed by the associated customs process.

It is also possible that a worklist is stored in the memory 12 of the data processing system 1. The worklist is a list including logistics data of the received goods that are necessary to create the electronic customs declaration documents required by the electronic customs clearance system. The worklist can be a virtual list in the memory 12 of the data processing system. The worklist is designed such that substantially all types of (electronic) logistics documents can be used as an input for the worklist; the interface structure between the electronic logistics document input (first input 2) and the data processing system 1 is common. The worklist provides the common interface between at least one electronic logistics document, e.g. mutually different logistics documents, and the data processing system 1. Thereto, the worklist may include a number of data entry fields. Each electronic logistics document may provide a selection of data entries to the worklist. The different types of electronic logistics documents may each provide a different selection of data entries to the worklist. Hence, the interface between the worklist and the electronic logistics documents is common. This provides the advantage that no separate interface structure is required for each logistics document but only a separate data extractor for each logistics document that supplies the relevant logistics data to the worklist. This allows compatibility of the worklist with a plurality of different logistics documents and/or easy modification of the data processing system 1 to be compatible with a new type of logistics document. It will be readily appreciated that it is also possible that the interface between the worklist and a predetermined number of groups of electronic logistics documents is common within each group of electronic logistics documents. For example, the interface between the worklist and electronic goods movement logistics documents can be common for all electronic goods movement logistics documents, while there is a separate interface between the worklist and electronic delivery documents, which e.g. close an NCTS procedure.

In the example of FIG. 2 the process 100 method includes receiving logistics data at the first input interface 2 of the data processing system 1 and adapting, in accordance with the received logistics data, the worklist stored in the memory 12 of the data processing system 1 (step 126), e.g. providing a selection of data entries of the logistics document to the worklist. From the worklist at least one customs procedure selection parameter is extracted (step 128), e.g. a plurality of selection parameters. For each of mutually different types of logistics documents at least one customs procedure selection parameter can be selected from the worklist. The at least one procedure selection parameter is output at the first output interface 8 of the data processing system 1, e.g. to a screen so as to be readable for a user of the data processing system. The user can for instance manually select a selection parameter of the at least one selection parameter by using selection means 20, e.g. by pressing a button on a keyboard. A selected procedure selection parameter can be received at the third input interface 6 of the data processing system 1. In response to selecting one or more of the selection parameters, a customs procedure definition is selected from the repository 14 (step 128) based on the received procedure selection parameter. The selected customs procedure definition at least defines a customs declaration (shipment) document type suitable to be processed by a customs clearance processing system corresponding to the selected customs process. The customs clearance document is generated corresponding to the customs clearance document type of the selected customs procedure definition and provided at the second output interface 10 of the data processing system 1.

In the above example the decision what customs procedure definition needs to be applied is made manually. In a special embodiment the decision what customs procedure definition needs to be applied can be made by automatism, e.g. when running the worklist in background mode for the appropriate selection parameters. An appropriate customs procedure definition may be selected automatically e.g. on the basis of a prioritized list of selection parameters and/or on the basis of values of predetermined selection parameters. In this case the selection may form an integral part of the data processing system 1 or may be implemented in software code and/or stored in the memory 12. The first output interface 8 and the third input interface 6 may be omitted in this case. As the user need not select a procedure selection parameter in this case, no selected selection parameter needs to be received at the third input interface 6, and therefore, no selection parameters need to be presented to the user through first output 8. Instead, the selection means 20 can be internal to the data processing system 1, so that sending the selection parameters to the selection means and sending the selected selection parameter to the data processing system is all performed internally in the data processing system 1. Automatically selecting the customs procedure definition provides the advantage that the risk of human errors may be reduced and/or that the speed of processing customs procedures for received goods may be increased.

The customs declaration document can also be generated automatically by the data processing system 1. Thereto, the processor 16 is arranged to select from the logistics data customs data suitable for the selected electronic customs procedure, and to generate from the customs data a customs declaration document suitable to be processed by the associated electronic customs procedure. It is also possible that the customs declaration document is transmitted to the customs clearance declaration system 18 automatically once the customs declaration document has been generated within the data processing system 1. This provides the advantage that the customs declaration document can be available to the customs authority substantially immediately after it has been generated.

Returning to FIG. 1, the data processing system 1 includes the first input interface 2 for receiving an electronic logistics document containing the logistics data of received goods, the second output interface 10 for providing the electronic customs declaration document and transmitting the electronic customs declaration document to the electronic customs clearance declaration system 18, the second input interface 4 for receiving customs clearance data from the electronic customs clearance declaration system, the memory 12 for storing the logistics data and the processor 16. The processor 16 is communicatively connected to the input interfaces, the memory, and the output interfaces. The processor 16 is arranged to extract from the logistics document logistics data, to derive from the extracted logistics data customs data related to a customs procedure, to generate for at least a part of the received goods an electronic customs declaration document containing the customs data, to provide the electronic customs declaration document at the second output interface 10, and to mark in accordance with the received clearance data the logistics data with a first marking to signal that the customs procedure has been completed when the clearance data indicate that the customs procedure has been completed.

The data processing system 1 further includes the repository 14 in which at least two customs procedure definitions are stored, which customs procedure definitions are each associated with at least one selection parameter and at least define a customs declaration document type suitable to be processed by an electronic customs clearance declaration system 18 corresponding to the customs procedure definition. The processor 16 is further arranged to select a customs procedure definition from the repository 14 and to generate a customs declaration document corresponding to the customs declaration document type of the selected customs procedure definition.

The data processing system 1 further includes the first output interface 8 for outputting the least one procedure selection parameter. The processor 16 is further arranged to adapt, in accordance with the received logistics data, a worklist stored in the memory 12 of the data processing system, to extract from the worklist at least one procedure selection parameter, to output the at least one procedure selection parameter at the first output interface 8 of the data processing system 1, to receive a selected procedure selection parameter at the third input interface 6 of the data processing system 1 and to select a customs procedure definition based on the received procedure selection parameter.

In an embodiment of the invention, the method includes inhibiting the processing of the logistics data of the received goods by the data processing system 1 until the customs clearance data indicate that the customs procedure has been completed and allowing the processing of the logistics data of the received goods by the data processing system 1, in case the customs clearance data indicate that the customs procedure has been completed. To achieve this, the processor 16 is arranged to inhibit a logistics process to be performed by the data processing system with received goods until the clearance data regarding the received goods indicate that the customs procedure has been completed. The processor may also be arranged to allow the logistics process to be performed by the processing system with received goods of which the clearance data indicate that the customs procedure has been completed. This provides the advantage that the logistics data of the received goods cannot be used in a logistics process as long as no customs clearance has been given for the received goods. This allows for secure handling of received goods for which customs charges are due. If the data processing system 1 is arranged to automatically handle customs clearance, the logistics data can be automatically marked by the processing system 1 to signal that the customs procedure has been completed immediately upon receiving the clearance data. It is then also possible to allow the processing of the logistics data by the data processing system 1 immediately upon receiving the clearance data. This provides the advantage that no time delay is experienced between receiving customs clearance and allowing the received goods to be used in the logistic process.

Within the data processing system 1, the logistics data may be provided with a second marking, which second marking signals that the customs procedure has not been completed. The second marking may be removed in case customs clearance data are received that indicate that the customs procedure has been completed. Removing the second marking when the customs procedure has been completed is also considered to be marking the logistics data with the first marking to signal that the customs procedure has been completed.

Alternatively, as adding the first marking to the logistics data signals that the customs procedure has been completed, not adding a first marking to the logistics data will signal that the customs procedure has not (yet) been completed. Thus, not adding a first marking to the logistics data can also be considered to be providing the logistics data with a second marking.

Change, use or manipulation of logistics data may be blocked until the customs procedure has been completed. Hence, change, use or manipulation of logistics data marked with the second marking may be blocked and change, use or manipulation of logistics data marked with the first marking may be allowed. The second marking can signal that the received goods are blocked or duty unpaid goods and/or the first marking can signal that the received goods are unblocked or duty paid goods. The logistics process can be allowed to be performed with the logistics data marked as unblocked. Marking the logistics data to signal that the customs procedure has been completed may also include transmitting the logistics data to a logistics system.

The customs authority may require that posting goods receipt is not allowed unless customs allows to do so. This means that the goods must be prevented from

showing up in material inventory records until the customs authority (or the custom clearance declaration system 18) gives customs clearance for the received goods. In an embodiment wherein the logistics document is a goods receipt, providing the second marking to the logistics data may include transmitting the goods receipt into a buffer memory and retaining the goods receipt in the buffer memory until the customs procedure has been completed. Removing the second marking from and/or applying the first marking to the logistics data may include discharging the goods receipt from the buffer memory.

In an embodiment the method further includes receiving goods (physical entities). In this case the goods can be retained in blocked stock until the customs clearance data indicate that the customs procedure has been completed. The goods can be released from blocked stock when the customs clearance data indicate that the customs procedure has been completed.

In the following examples, the invention is applied to a system sold by SAP Global Trade Services, which is a computer program suitable to be loaded and run by one or more programmable devices, such as general purpose computers, personal digital assistants (PDAs) or otherwise.

### EXAMPLE 1

### Starting New Customs Procedure

Choosing a new customs procedure e.g. after having closed the transit procedure will be made out of the customs workload. This central worklist receives inbound logistics data that are necessary to create customs shipments documents in order to communicate with customs. The worklist is filled with data coming from a logistics document posted in the feeder system e.g. goods receipts. The interface structure between the feeder system and the SAP Global Trade Services system (SAP GTS) is common and suitable for all types of documents in the feeder system. You don't need a separate interface structure for each logistic document but only a separate data extractor for each document that supplies the interface with logistics data. In an alternative embodiment, you need an interface structure for each of a predetermined number of groups of electronic logistics documents.

The selection screen of the customs worklist functionally comprises all characteristics received from logistics as selection parameters. Hence, the decision what customs procedure needs to be applied can be made manually or by automatism when running the customs worklist in background mode for the appropriate selection parameters.

Referring to FIG. 2, the logistics document is posted in the feeder system e.g. goods receipts (step 104). If it is determined that a customs declaration is required (step 106) the logistics data is extracted from the logistics document (step 110). The interface structure between the feeder system and the SAP Global Trade Services system (SAP GTS) is common and suitable for all types of documents in the feeder system. The extracted inbound logistics data that are necessary to create customs shipments documents in order to communicate with customs presented to the SAP GTS are stored in the worklist (step 126). The worklist is thus filled with data coming from the logistics document. From the worklist, selection parameters are extracted (step 128) and, in this example, shown in the selection screen. The selection screen of the customs worklist functionally comprises all characteristics received from logistics as selection parameters. Now, the decision what customs procedure needs to be applied can be made manually (step 124). The decision what customs procedure needs to be applied can also be made by automatism when running the customs worklist in background mode for the appropriate selection parameters. In the logistics document a customs reference number may be added and/or an identifier of the selected customs procedure. The logistics data may be marked with the second marking to signal that the customs procedure has not been completed at this point.

### EXAMPLE 2

### Closing a Transit Procedure

Closing customs transit procedure is based on the inbound delivery document (IBD). In the SAP system, the inbound delivery document contains data about a process of receiving goods at a receiving area, such as the purchase order and the shipping notification. In the inbound delivery document a customs reference number is added. If this number got assigned to the IBD customs relevant data to the customs process to which the customs reference number refers will be transmitted to the SAP Global Trade Services system (SAP GTS) a customs shipment document (CSD) suitable to be processed by the associated customs process will be created. Based on the CSD the communication with customs takes place.

Customs may require that posting goods receipt is not allowed unless customs allows to do so. This means that the goods must be prevented from showing up in your material inventory records until customs gives green light. Within the integration steps this requirement will be satisfied by posting the goods receipt into blocked stock when a customs reference number got assigned to the IBD representing a transit procedure. When SAP GTS receives customs permission, SAP GTS triggers the feeder system to post real goods receipt out of blocked stock by automatism.

Referring to FIG. 2, when the appropriate customs procedure has been selected, as shown in example 1, in the inbound delivery document a customs reference number is added. If this customs reference number got assigned to the IBD, customs data, relevant to the customs process to which the customs reference number refers, will be transmitted to the SAP Global Trade Services system (SAP GTS). Based on the selected customs procedure and the logistics data, a customs shipment document (CSD) suitable to be processed by the associated customs process will be created (step 114). Based on the CSD the communication with customs takes place, i.e., the customs shipment document is transmitted to the customs authority (step 116) and customs clearance data is received from the customs authority (step 118). When customs clearance is received, the logistics data may be marked with a first marking to signal that the customs procedure has been completed (step 120).

Customs may require that posting goods receipt is not allowed unless customs allows to do so. This means that the goods must be prevented from showing up in your material inventory records until customs gives green light. Within the integration steps this requirement will be satisfied by posting the goods receipt into blocked stock. The goods receipt may be posted in blocked stock e.g. when the logistics data were marked with the second marking to signal that the customs procedure has not been completed, or when the customs reference number got assigned to the IBD, representing a transit procedure.

When SAP GTS receives customs permission, from the customs authority, SAP GTS triggers the feeder system to post real goods receipt out of blocked stock by automatism, e.g. by marking the logistics data with a first marking to signal that the customs procedure has been completed, so that the logistics process recognizes the logistics data as belonging to goods for which the customs procedure has been completed. Posting real goods receipt out of blocked stock by automatism provides the advantage that after receiving customs clearance the goods are immediately available for further logistic processing, without requiring action of the user.

It should be noted that the above-mentioned embodiments and examples illustrate rather than limit the invention, and that those skilled in the art will be able to design alternatives without departing from the scope of the appended claims. For example in the examples the worklist is stored in the memory of the data processing system. It is also possible that the worklist is stored in a memory of a customs procedure unit of the data processing system. In this case the method may include transferring (at least part of) the logistics data to the customs procedure unit.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method for performing a customs procedure, the method comprising:
receiving, at a first input interface of a data processing system, an electronic logistics document, the logistics document containing logistics data of received goods;
generating, by the data processing system, an electronic customs declaration document, the generating the electronic customs declaration document comprising:
extracting, from the logistics document, logistics data;
deriving, from the extracted logistics data customs data related to a customs procedure; and
generating, for at least a part of the received goods, by the data processing system, the electronic customs declaration document containing the customs data;
providing the electronic customs declaration document at an output interface of the data processing system;
transmitting the electronic customs declaration document to an electronic customs clearance declaration system;
receiving, from the electronic customs clearance declaration system, clearance data regarding the received goods at a second input interface of the data processing system; and
marking, within the data processing system, the logistics data with a first marking to signal that the customs procedure has been completed when the clearance data indicate that the customs procedure has been completed;
wherein the generating the customs declaration further comprises:
automatically selecting a customs procedure definition from a repository.

2. The method of claim 1 further comprising automatically determining from the logistics data whether or not a customs declaration is required for the received goods.

3. The method of claims 2 wherein the automatically selecting a customs procedure definition from a repository comprises:
automatically selecting a customs procedure definition from a repository stored in a memory of the data processing system, which customs procedure definition at least defines a customs declaration document type suitable to be processed by the electronic customs clearance declaration system corresponding to the selected customs procedure; and
wherein generating the customs declaration further comprises:
generating a customs declaration document corresponding to the customs declaration document type of the selected customs procedure definition.

4. (canceled)

5. The method of claim 3 further comprising adding an identifier of the selected customs procedure definition to the logistics data.

6. The method of claim 5 further comprising:
adapting, in accordance with the received logistics data, a worklist stored in a memory of the data processing system;
extracting from the worklist at least one procedure selection parameter;
outputting the at least one procedure selection parameter at an output interface of the data processing system;
receiving a selected procedure selection parameter at an input interface of the data processing system; and
selecting a customs procedure definition based on the received procedure selection parameter.

7. The method of claim 6 wherein the worklist enables a common interface between at least one electronic logistics document and the data processing system.

8. The method of claim 7 wherein the worklist enables a common interface between a predetermined number of groups of electronic logistics documents and the data processing system.

9. The method of claim 8 wherein the worklist is stored in a memory of a customs procedure unit of the data processing system, and wherein the method further comprises transferring at least part of the logistics data to the customs procedure unit.

10. The method of claim 9 further comprising automatically marking the logistics data to signal that the customs procedure has been completed when the received clearance data indicate that the customs procedure has been completed.

11. The method of claim 10 further comprising inhibiting processing of the logistics data by the data processing system until the customs clearance data indicate that the customs procedure has been completed.

12. The method of claim 11 further comprising allowing processing of the logistics data by the data processing system, in case the customs clearance data indicate that the customs procedure has been completed.

13. The method of claim 12 further comprising providing, within the data processing system, the logistics data with a second marking, which second marking signals that the customs procedure has not been completed, and removing the second marking in case customs clearance data are received that indicate that the customs procedure has been completed.

14. The method of claim 13 wherein change, use or manipulation of logistics data marked with the second marking is blocked.

15. The method of claim 14 wherein providing the logistics data with the second marking signals that the received goods are blocked or duty unpaid goods.

16. The method of claim 15 wherein the logistics document is a goods receipt and wherein the providing a second marking to the logistics data comprises transmitting the goods receipt into a buffer memory and retaining the goods receipt in the buffer memory until the customs procedure has been completed.

17. The method of claim 16 removing the second marking from the logistics data or providing the first marking to the logistics data comprising discharging the goods receipt from the buffer memory.

18. The method of claim 17 wherein change, use or manipulation of logistics data marked with the first marking is allowed.

19. The method of claim 18 wherein providing the logistics data with the first marking signals that the received goods are unblocked or duty paid goods.

20. The method of claim 19 further comprising:
retaining received goods in blocked stock until the customs clearance data indicate that the customs procedure has been completed; and
releasing the goods from blocked stock when the customs clearance data indicate that the customs procedure has been completed.

21. A data processing system comprising:
a first input interface for receiving an electronic logistics document containing logistics data of received goods;
an output interface for providing an electronic customs declaration document and transmitting the electronic customs declaration document to the electronic customs clearance declaration system;
a second input interface for receiving customs clearance data from the electronic customs clearance declaration system;
a memory for storing the logistics data;
a processor connected to the input interfaces, the memory, and the output interfaces, the processor being arranged to extract from the logistics document logistics data, to derive from the extracted logistics data customs data related to a customs procedure, to generate for at least a part of the received goods an electronic customs declaration document containing the customs data, to provide the electronic customs declaration document at the output interface, and to mark in accordance with the received clearance data the logistics data with a first marking to signal that the customs procedure has been completed when the clearance data indicate that the customs procedure has been completed, the processor being further arranged to automatically select a customs procedure definition from a repository.

22. The data processing system of claim 21 wherein at least two customs procedure definitions are stored in the repository, which customs procedure definitions are each associated with at least one selection parameter and at least define a customs declaration document type suitable to be processed by an electronic customs clearance declaration system corresponding to the customs procedure definition, and
procedure definition from the repository, and wherein the processor is further arranged to generate a customs declaration document corresponding to the customs declaration document type of the selected customs procedure definition.

23. The data processing system of claim 22 further comprising a first output interface for outputting the least one procedure selection parameter, wherein the processor is further arranged
to adapt, in accordance with the received logistics data, a worklist stored in a memory of the data processing system, to extract from the worklist at least one procedure selection parameter; to output the at least one procedure selection parameter at the first output interface of the data processing system, to receive a selected procedure selection parameter at a third input interface of the data processing system, and to select a customs procedure definition based on the received procedure selection parameter.

24. The data processing system of claim 23 wherein the processor is arranged to add an identifier of a selected customs procedure to the logistics data.

25. The data processing system of claim 24 wherein the processor is arranged to mark the logistics data with a second marking to signal that a customs procedure has not been completed until the clearance data indicate that the customs procedure has been completed.

26. The data processing system of claim 25 wherein the processor is arranged to inhibit a logistics process to be performed by the data processing system with the logistics data until the clearance data regarding the received goods indicate that the customs procedure has been completed.

27. The data processing system of claim 26 wherein the processor is arranged to allow a logistics process to be performed by the processing system with the logistics data in case the clearance data indicate that the customs procedure has been completed.

28. A non-transitory machine readable storage device storing instructions executable by one or more processors to result in a method comprising:
receiving, at a first input interface of a data processing system, an electronic logistics document, the logistics document containing logistics data of received goods;
generating, by the data processing system, an electronic customs declaration document, the generating the electronic customs declaration document comprising:
extracting, from the logistics document, logistics data;
deriving, from the extracted logistics data, customs data related to a customs procedure; and
generating, for at least a part of the received goods, by the data processing system, the electronic customs declaration document containing the customs data;
providing the electronic customs declaration document at an output interface of the data processing system;
transmitting the electronic customs declaration document to an electronic customs clearance declaration system;
receiving, from the electronic customs clearance declaration system, clearance data regarding the received goods at a second input interface of the data processing system; and
marking, within the data processing system, the logistics data with a first marking to signal that the customs procedure has been completed when the clearance data indicate that the customs procedure has been completed;
wherein the generating the customs declaration further comprises:
automatically selecting a customs procedure definition from a repository.

29. The non-transitory machine readable storage device of claim 28, wherein the method further comprises automatically determining from the logistics data whether or not a customs declaration is required for the received goods.

30. The non-transitory machine readable storage device of claim 29, wherein the automatically selecting a customs procedure definition from a repository comprises:
automatically selecting a customs procedure definition from a repository stored in a memory of the data processing system, which customs procedure definition at least defines a customs declaration document type suitable to be processed by the electronic customs clearance declaration system corresponding to the selected customs procedure; and
wherein generating the customs declaration further comprises:
generating a customs declaration document corresponding to the customs declaration document type of the selected customs procedure definition.
